(19) United States
(12) Patent Application Publication
(10) Pub. No.: US 2026/0206800 A1
(43) Pub. Date: Jul. 23, 2026

(54) Composition for beverage clarification

(71) Applicant: YISSUM RESEARCH DEVELOPMENT COMPANY OF THE HEBREW UNIVERSITY OF JERUSALEM LTD., Jerusalem (IL)

(72) Inventors: Yael MISHAEL, Rehovot (IL); Roi ALFORD, Moshav Manof (IL)

(21) Appl. No.: 19/137,074

(22) PCT Filed: Dec. 14, 2023
(86) PCT No.: PCT/IL2023/051271

§ 371 Date: Jun. 10, 2025

Related U.S. Application Data
(60) Provisional application No. 63/432,507, filed on Dec. 14, 2022.

(51) Int. Cl. A23L 2/80; A23L 5/20; B01J 20/12; B01J 20/32; C12H 1/044; C12H 1/056

(52) U.S. Cl. CPC A23L 2/80; A23L 5/273; B01J 20/12; B01J 20/3204; B01J 20/3221; B01J 20/327; B01J 20/3274; C12H 1/0408; C12H 1/0424

(57) ABSTRACT

The invention provides a method for reducing the amount of one or more undesired agents in a beverage, comprising: a) contacting the beverage with a composite adsorbent which comprises a montmorillonite (MMT) clay with a consumable polyelectrolyte adsorbed onto the clay, wherein charged binding sites of the clay are partially masked; b) maintaining or applying conditions enabling binding of the undesired agent(s) to the composite adsorbent of (a); and c) separating the composite adsorbent, with undesired agent bound thereto, from the beverage.

### BACKGROUND OF THE INVENTION

One of the major concerns regarding food safety is mycotoxins, secondary metabolites produced by filamentous moulds (fungi), where the most studied mycotoxins are aflatoxins, zearalenone, fumonisins, trichothecenes and ochratoxins. One of the prevalent mycotoxins is ochratoxin A (OTA), which is produced by several species of Aspergillus and Penicillium fungi. OTA is present in a wide variety of agricultural commodities, the most relevant being cereal grains, dried fruits, coffee, and wine. OTA is a weak organic acid (pKa of 4.4 and 7.3) that can endure extreme conditions (such as high temperatures and high acidity) without undergoing degradation due to its stable structure, thus making this molecule particularly difficult to remove from contaminated foodstuffs. OTA is known to cause severe health issues when consumed, including carcinogenic and nephrotoxic potential.

To prevent OTA contaminated food, pre- and post-harvest strategies can be applied. For example, in wine and grape juice (GJ) production, the pre-harvest strategies are based on preventing mould growth in the field or during storage and transportation of stock, thereby preventing mycotoxin formation. These strategies are based on sanitation and storage standards which are insufficient in many cases. Ideally, a post-harvest OTA treatment strategy should be based on integrating a well-known oenological practice, for example employing wine-fining adsorbing agents, such as egg albumin, casein, gelatine, activated charcoal, polyvinylpolypyrrolidone (PVPP), and the widely used commercial montmorillonite (MMT) clay, bentonite (BT).

Different oenological fining agents have been tested for OTA treatment in wine. However, OTA reduction was relatively low, not always meeting the limit set by the EU and The International Wine and Vine Organization, which is 2 μg/L for wine/must (being crushed grape mass for fermentation)/grape juice. Additionally, in many cases, the treatment impacted wine quality in various parameters such as color, phenolic compounds content, and anthocyanins. Nonetheless, sorbents are considered low-cost and simple to apply with some degree of success, depending on the adsorbent and the dosage applied. For example, the adsorption of OTA to inorganic (e.g., BT, kaolinite, activated carbon, silica gel, etc.) and organic (e.g., cellulose, egg albumin, gelatine, PVPP, etc.) fining agents in red wine ranged from 1-61% and 1-40%, respectively [Castellari, M.; Versari, A.; Fabiani, A.; Parpinello, G. P.; Galassi, S. Removal of Ochratoxin A in Red Wines by Means of Adsorption Treatments with Commercial Fining Agents. J. Agric. Food Chem. 2001, 49 (8), 3917-3921; Solfrizzo, M.; Avantaggiato, G.; Panzarini, G.; Visconti, A. Removal of Ochratoxin a from Contaminated Red Wines by Repassage over Grape Pomaces. J. Agric. Food Chem. 2010, 58 (1), 317-323)]. Chitosan was found to be efficient (~70%) for the adsorption of OTA from red wine, but it strongly affected the wine quality parameters, while chitin did not affect wine quality, it only adsorbed 18% OTA. The adsorption of OTA by BT (1 g/L), one of the most common fining agents, was explored but found relatively low (~8-31%) [see Quintela, S.; Villarin, M. C.; Armentia, I. L. De; Elejalde, E. Ochratoxin A Removal from Red Wine by Several Oenological Fining Agents: Bentonite, Egg Albumin, Allergen-Free Adsorbents, Chitin and Chitosan; Food Addit. Contam. 2012, 29 (7), 1168-1174; and Kurtbay, H. M.; Bekçi, Z.; Merdivan, M.; Yurdakog, K. Reduction of Ochratoxin A Levels in Red Wine by Bentonite, Modified Bentonites, and Chitosan. J. Agric. Food Chem. 2008, 56 (7), 2541-2545].

The primary applications of BT are to improve wine stability and clarification by adsorption. Wine stability is achieved by eliminating proteins that are a potential source of haze, while clarification is facilitated by precipitation of suspended solids (applied mainly on must and young wines) [see Rankine, B. C.; Emerson, W. W. Wine Clarification and Protein Removal by Bentonite. J. Sci. Food Agric. 1963, 14 (10), 685-689; and Lambri, M.; Dordoni, R.; Silva, A.; de Faveri, D. M. Comparing the Impact of Bentonite Addition for Both Must Clarification and Wine Fining on the Chemical Profile of Wine from Chambave Muscat Grapes. Int. J. Food Sci. Technol. 2012, 47 (1), 1-12]. Although OTA adsorption by BT was low, upon organo-modifying the clay its adsorption somewhat improved [Kurtbay et al., supra].

There is an immense interest in organo-modified clays as sorbents in many fields, including water treatment, pharmaceutical industries, environmental applications, and food processing, due to their simplicity, inexpensive production, and efficiency [see Pereira, E. I.; Minussi, F. B.; Da Cruz, C. C. T.; Bernardi, A. C. C.; Ribeiro, C. Urea-Montmorillonite-Extruded Nanocomposites: A Novel Slow-Release Material. J. Agric. Food Chem. 2012, 60 (21), 5267-5272; Shabtai, I. A.; Lynch, L. M.; Mishael, Y. G. Designing Clay-Polymer Nanocomposite Sorbents for Water Treatment: A Review and Meta-Analysis of the Past Decade. Water Research. Elsevier Ltd Jan. 1, 2021, p 116571; and Bortolin, A.; Serafim, A. R.; Aouada, F. A.; Mattoso, L. H. C.; Ribeiro, C. Macro- and Micronutrient Simultaneous Slow Release from Highly Swellable Nanocomposite Hydrogels. J. Agric. Food Chem. 2016, 64 (16), 3133-3140]. More specifically, polymer-tailored clay sorbents, clay-polymer nanocomposites (CPNs), are extremely promising [see Zusman, O. B.; Perez, A.; Mishael, Y. G. Multi-Site Nanocomposite Sorbent for Simultaneous Removal of Diverse Micropollutants from Treated Wastewater. Appl. Clay Sci. 2021, 215, 106300; Jin, M.; Zhong, Q. Structure Modification of Montmorillonite Nanoclay by Surface Coating with Soy Protein. J. Agric. Food Chem. 2012, 60 (48), 11965-11971; and Beltrán, A.; Valente, A. J. M.; Jim\tilde{e}nez, A.; Garrigós, M. C. Characterization of Poly(ε-Caprolactone)-Based Nanocomposites Containing Hydroxytyrosol for Active Food Packaging. J. Agric. Food Chem. 2014, 62 (10), 2244-2252]. Clay imparts important properties to the performance of CPNs, including its large surface area, low toxicity, low cost, and mechanical stability. Tailoring CPNs by polymer selection enables the enhancement of adsorption of specific target molecules based on polymer-sorbate interactions. For example, winery wastewater treated by a sepiolite-polymer CPN was clarified completely in less than 2 min vs. 24 h for non-modified sepiolite or alum while the polymer (without clay) did not improve clarification [see Rytwo, G. The Use of Clay-Polymer Nanocomposites in Wastewater Pretreatment. Sci. World J. 2012, 2012]. Furthermore, when aiming to adsorb negatively charged molecules, CPNs composed of polycations resulted in better performance compared to bare clay [Zusman et al, supra].

The adsorption of the herbicide atrazine to four different CPNs was also studied, based on various polymers, and its adsorption was found especially high upon the formation of hydrogen bonds and n-n stacking interactions between the herbicide and a suitable polymer [Gardi, I.; Nir, S.; Mishael, Y. G. Filtration of Triazine Herbicides by Polymer-Clay Sorbents: Coupling an Experimental Mechanistic Approach with Empirical Modeling. Water Res. 2015, 70, 64-73].

More specifically, it was shown that the polymer configuration upon the CPN has an important effect on micropollutant adsorption from complex matrixes. Polycation adsorption configuration on the negatively charged clay surface is modulated by polymer charge density or by solution ionic strength (IS) [see Bauer, D.; Buchhammer, H.; Fuchs, A.; Jaeger, W.; Killmann, E.; Lunkwitz, K.; Rehmet, R.; Schwarz, S. Stability of Colloidal Silica, Sikron and Polystyrene Latex Influenced by the Adsorption of Polycations of Different Charge Density. Colloids Surfaces A Physicochem. Eng. Asp. 1999, 156 (1-3), 291-305; Shin, Y.; Roberts, J. E.; Santore, M. M. Influence of Charge Density and Coverage on Bound Fraction for a Weakly Cationic Polyelectrolyte Adsorbing onto Silica. Macromolecules 2002, 35 (10), 4090-4095; Kohay, H.; Bilkis, I. I.; Mishael, Y. G. Effect of Polycation Charge Density on Polymer Conformation at the Clay Surface and Consequently on Pharmaceutical Binding. J. Colloid Interface Sci. 2019, 552, 517-527; Dobrynin, A. V.; Rubinstein, M. Effect of Short-Range Interactions on Polyelectrolyte Adsorption at Charged Surfaces. J. Phys. Chem. B 2003, 107 (32), 8260-8269; Xie, F.; Nylander, T.; Piculell, L.; Utsel, S.; Wdgberg, L.; Åkesson, T.; Forsman, J. Polyelectrolyte Adsorption on Solid Surfaces: Theoretical Predictions and Experimental Measurements. Langmuir 2013, 29 (40), 12421-12431; and Van de Steeg, H. G. M.; Cohen Stuart, M. A.; De Keizer, A.; Bijsterbosch, B. H. Polyelectrolyte Adsorption: A Subtle Balance of Forces. Langmuir 1992, 8 (10), 2538-2546].

Adsorption from low IS or adsorption of high charge density polymers induces direct interaction between the polymer and the clay surface, resulting in a ‘train’ configuration. On the other hand, as IS increases or polymer charge density decreases, polymer configuration shifts towards a more extended configuration such as ‘loops & tails’ accompanied by greater polymer loading. For example, CPNs with a configuration of ‘loops & tails’ based on 100% methylated poly-4-vinylpyridine-co-styrene (QPVP), obtained by increasing polymer solution IS, was found beneficial for the adsorption of anionic micropollutants [Shabtai, I. A.; Mishael, Y. G. Efficient Filtration of Effluent Organic Matter by Polycation-Clay Composite Sorbents: Effect of Polycation Configuration on Pharmaceutical Removal. Environ. Sci. Technol. 2016, 50 (15)].

Additionally, a CPN based on poly-4-vinylpyridine (PVP) with only 50% ethanol substitution (OH50PVP), i.e., low charge density polymer, also resulted in a ‘loops & tails’ configuration with beneficial adsorption of an anionic micropollutant [Levy, L.; Izbitski, A.; Mishael, Y. G. Enhanced Gemfibrozil Removal from Treated Wastewater by Designed “Loopy” Clay-Polycation Sorbents: Effect of Diclofenac and Effluent Organic Matter. Appl. Clay Sci. 2019, 182 (August)]. Moreover, the CPNs showed an advantage in pollutant removal even from complex matrixes such as treated wastewater (TWW) compared to the commercially used sorbent [see Zusman, supra and Shabtai, I. A.; Mishael, Y. G. Efficient Filtration of Effluent Organic Matter by Polycation-Clay Composite Sorbents: Effect of Polycation Configuration on Pharmaceutical Removal. Environ. Sci. Technol. 2016, 50 (15)].

A few examples from the patent literature on the use of clays, such as montmorillonite, as adsorbent materials in the treatment of beverages include GB 465692 and U.S. Pat. No. 2,291,624 (both deal with the treatment of beer), GB 1255370 (chemically-modified montmorillonite was produced by suspending the natural mineral and added silica in water, followed by acidification and boiling; the resultant product was collected by filtration, drying and grinding), WO 93/15832 (clarification of aqueous liquids with acid-treated mineral clay) and WO 02/070643 (attapulgite, bentonite and kaolin were tested for color reduction of a wort and removal of protein from a wort).

### SUMMARY OF THE INVENTION

The present invention is based on the realization that when montmorillonite (MMT) clay is used for beverage clarification (such as for wine clarification) much of the “wasted” beverage entrapped in the MMT (that can be up to 20% of the beverage) is due to the hydration properties of the charged MMT particles. The inventors of the present invention realized that by partially masking some of the charged sites of the MMT, the hydration layer around the MMT particles is reduced and a smaller amount of the beverage is lost (nearly an order of magnitude less compared to neat MMT).

The MMT clay needs to be partially masked by the polymer so as to maintain enough unmasked ionic MMT sites to bind and remove undesired agents from the beverage.

The inventors surprisingly found that although in the MMT-polymer composite some of the binding sites of the clay were masked by the polymer, the removing ability of the complex was as good or better when compared to “bare” MMT where all the binding sides were available for binding. MMT has certain types of binding sites while the composite contains these sites (since the polymer does not cover the entire MMT surface) but has additional binding sites (of the polymer) which can attract molecules to be removed.

Accordingly, the invention is a method for reducing amounts of undesired agents in a beverage, the method comprising:
a) contacting the beverage with a composition of matter, (i.e., a composite adsorbent), being montmorillonite (MMT) clay complexed with a consumable polyelectrolytic polymer adsorbed onto the clay, said absorption partially masking clay charged binding sites,
b) maintaining or applying conditions enabling binding of the undesired agent to the composition of matter (i.e., to the composite adsorbent) of (a); and
c) separating the composition of matter (i.e., the composite adsorbent) bound to the undesired agent from the beverage. That is, the invention provides a method for reducing the amount of one or more undesired agents in a beverage, comprising:
a) contacting the beverage with a composite adsorbent which comprises a montmorillonite (MMT) clay with a consumable polyelectrolyte complexed with, namely, adsorbed onto, the clay, wherein charged binding sites of the clay are partially masked;
b) maintaining or applying conditions enabling binding of the undesired agent(s) to the composite adsorbent of (a); and
c) separating the composite adsorbent, with undesired agent bound thereto, from the beverage.

Another aspect of the present invention is a composition of matter, namely, composite adsorbent, for use in a method of reducing amounts of undesired agents in a beverage, comprising montmorillonite (MMT) clay complexed with a consumable polyelectrolytic polymer adsorbed onto the clay, said absorption partially masking clay-charged binding sites.

The beverage of the invention may be wine, juices of all kinds, especially fruit juice and in particular grape juice, beer, and fermented drinks such as kombucha.

The undesirable agent is selected from particles of skins, seeds, and stems of the fruit from which the beverage is made (in cases of wine or juice); and particles of the grains from which the beer is made. The undesired agent may also be a haze-forming protein. Other undesired agents include bacteria, fungi, or toxic substances originating from microorganisms such as mycotoxins examples being aflatoxins, zearalenone, fumonisins, trichothecenes and ochratoxins, and in particular ochratoxin A.

The composite adsorbent comprises particulate MMT clay. The term “particulate MMT” is related to a phyllosilicate MMT mineral with a nanolayered structure. Its layered structure (ca. 1 nm in thickness) consists of stacked layers, and each layer is composed of two O—Si—O tetrahedral sheets sandwiching one O—Al(Mg)—O octahedral sheet (ca. 100 nm×100 nm, in width and length). Due to the isomorphous substitution, the layer is charged, with exchangeable cations existing in the interlayered space of MMT. Neighboring layers are held together primarily by van der Waals force and electrostatic force to form the primary particles of MMT. The particles then aggregate to form secondary micrometer-scale to millimeter-scale particles.

The size of the particles of the neat MMT (before the adsorption/modification with the polyelectrolyte) is typically in the range from 1 to 10 μm. The particle size of a composite adsorbent according to the invention is from 100 to 500 μm.

Consumable polyelectrolyte is applied onto the clay. The term “consumable” refers to a polymer (i.e., polyelectrolyte; the terms polymer/polyelectrolyte are used herein interchangeably) that can be used in the food industry. The polymer may be edible (such as polysaccharide, peptide, or protein) or a GRAS (Generally Recognized as Safe) approved polymer where small residual amounts or traces are allowed in food or beverages. The polymer is a polyelectrolyte, which is electrostatically adsorbed onto the clay. The polymer may be polycationic or polyanionic. When desired to remove mycotoxins such as OTA the polymer should be polycationic.

Non-limiting examples of consumable polyelectrolyte polymers are: polysaccharides (e.g., chitosan, kappa-carrageenan (derived from edible red algae, (C₁₂H₁₆SO₁₂)⁻ₙ)), peptides, proteins, polymers (e.g., poly-DADMAC (C₈H₁₆NCl)ₙ), anionic polyacrylamide (used for water treatment) (C₃H₅NO)ₘ(C₃H₃O₂Na)ₙ.

The present invention further concerns a composition of matter (i.e., a composite adsorbent) comprising carrageenan (e.g., kappa-carrageenan) adsorbed on MMT, and a composition of matter (i.e., a composite adsorbent) comprising poly (vinylbenzyl trimethylammonium) adsorbed on MMT.

As only some of the binding sites of the clay need to be masked by the polymer (to reduce clay swelling and sediment volume) and some need to be exposed (to bind the undesired agent) the ratio between the clay and the polyelectrolytic polymer, and the conditions with which the polymer is contacted with the clay (ionic strength (and optionally also the pH) should be tailored.

This can be done by trying varying ratios of clay to polymer and various ionic strengths and testing both the amount of sediment and the removal level of a test undesired agent (protein)—as was done in the experimental section below.

Typically, the weight ratio of clay: polymer (during preparation) which gives partial masking is between 1:1 and 160:1, e.g., between 1:5 and 160:1. The ionic strength (such as NaCl concentration in M) is between 0.01M to 1M.

By another aspect the present invention provides a method for preparing a composition of matter, i.e., a composite adsorbent, for reducing amounts of undesired agents in a beverage, wherein the composition of matter/composite adsorbent comprises MMT clay complexed with a consumable polyelectrolytic polymer adsorbed onto the clay, said adsorption partially masking clay charged binding sites, wherein the method of preparation comprises:
a) contacting varying ratios of MMT clay and polymer under varying ionic strength to produce a plurality of different complexes;
b) contacting each of the complexes from step a) with a test liquid (such as water) comprising a test agent to be removed (such as protein);
c) allowing the complex to sediment, and measuring the volume of the supernatant and determining the volume of liquid entrapped in the sediment and the amount of test agent removed by each complex; and
d) selecting the complex with a desired level of liquid loss and undesired agent removal.

The conditions that enable the binding of the composition of the invention to the undesired agent include the amount of the composition added to a volume of the beverage. This amount depends on the wine—different wines need different amounts. Typically, it is about 0.1 g/L to 2 g/L, the time the two are in contact with each other is typically between 1 hour and 7 days, e.g., between 1 day to 7 days, under stirring.

Finally, the composition of the invention bound to the undesired agent is removed from the liquid-holding vessel by filtration, centrifugation or sedimentation.

### DETAILED DESCRIPTION OF THE INVENTION

The particle size of the neat MMT (before the adsorption/modification with the polyelectrolyte) is from 1 to 10 μm, and correspondingly, the MMT powder possesses high surface area, e.g., BET specific surface area >500 m²/g. Preferred MMT for use in the preparation of a composite adsorbent according to the invention (also named herein CPNs) has high cation exchange capacity (CEC), greater than 30 milliequivalents/100 g, e.g., CEC >50 milliequivalents/100 g, such as CEC >70 milliequivalents/100 g, e.g., 70<CEC<100 milliequivalents/100 g, (at pH=7). Montmorillonite (MMT), with sodium and/or calcium exchangeable cations, preferably sodium-rich montmorillonite (Na-MMT, such as Na-exchanged Wyoming montmorillonite), onto which organic cations are strongly adsorbed, i.e., by displacing the alkali/alkali earth cations, was used in the experimental work reported herein and was shown to give good results. That is, MMT, Na-MMT and any montmorillonite-based clay, i.e., minerals consisting mostly of MMT or Na-MMT, such as bentonite, are especially preferred according to the invention. Hereinafter these minerals are collectively indicated by the abbreviation MMT, unless specifically indicated otherwise. It should be noted that the invention is not limited to the use of natural minerals, synthetic analogues such as those reported by LE Forestier et al. [Textural and hydration properties of a synthetic montmorillonite compared with a natural Na-exchanged clay analogue; Applied Clay Science, Elsevier, 2010, 48, pp. 18-25. 10.1016/j.clay.2009.11.038. insu-00433524] can also be used.

As to the water-soluble polyelectrolytes for use in the invention, they fall into two groups based on their charge.

Cationic polymers have a repeat unit comprising a quaternary nitrogen, e.g., in a pendant group, wherein the nitrogen atom may be a ring atom (i.e., part of a five or six-membered ring; the ring may be aromatic or nonaromatic) or is part of acyclic group (e.g., N⁺R₁R₂R₃R₄, R₁, R₂, R₃ and R₄ are independently selected from hydrogen, C1-C3 alkyl and aromatic rings, e.g., benzene).

For example, the repeat unit comprises a pendant group attached to the polymer backbone chain, the pendant group having an aromatic ring to which acyclic quaternary nitrogen is bonded, e.g., ∫—R₁—N⁺R₂R₃R₄, wherein f is the polymer backbone chain, R₁ is an aromatic ring and R₂R₃R₄ are as previously defined. The corresponding ammonium salts have negative counterions which are often halides (e.g., chloride).

Polyanionic polymers usually have acidic groups which can undergo deprotonation to assume a negative charge, such as carboxylic and sulfonic acids groups, and are available as corresponding metal salts, e.g., sodium salts.

A few examples of some preferred polycationic and polyanionic polymers are depicted below.

### Polycations:

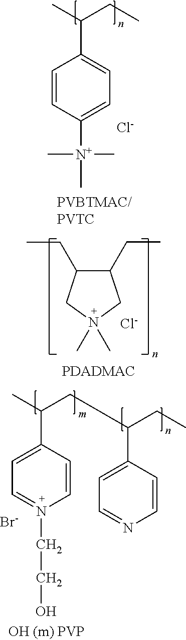

### Polyanions:

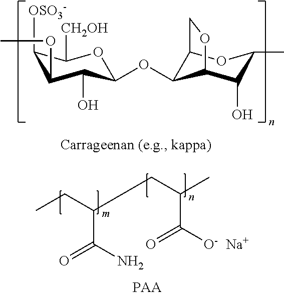

Poly(vinylbenzyl trimethyl ammonium chloride), abbreviated PVBTMAC or PVTC; the two abbreviations are used herein interchangeably; poly(diallyl dimethyl ammonium chloride), abbreviated PDADMAC; kappa-carrageenan and polyacrylamide, abbreviated PAA, are commercially available. Poly-4-vinyl(1-(2-hydroxyethyl) pyridinium bromide (abbreviated OHmPVP) can be prepared by the synthesis described by Levy et al. (supra), with substitution level expressed as percentage of positively charged pyridine rings bearing the hydroxyethyl moiety; the abbreviation OHmPVP denotes the polymer with m representing the substitution level. For example, OH50PVP, which was tested in the experimental work reported below, indicates that 50% of the total number pyridine rings (m+n) are alkylated. In general, 25 m 70%. A cationic polymer with such low-medium charge density exhibits useful properties as shown below.

For example, the amount of ochratoxin A in beverages can be reduced effectively with the aid of the poly(vinylbenzyl trimethyl ammonium) cation, and the amount of haze forming polymers can be reduced effectively with the aid of poly(diallyl dimethyl ammonium) cation or the anionic polymer carrageenan.

In its most general form, a composite adsorbent according to the invention is prepared by suspending the clay particles (MMT) in water, or in an electrolyte solution, in the presence of a solubilized consumable polyelectrolyte.

For example, a composite adsorbent according to the invention is prepared by addition of an aqueous solution of the polyelectrolyte (prepared beforehand by dissolving polyelectrolyte in water, e.g., distilled water, or in an electrolyte solution, reaching concentration of 0.005 to 5 g/liter, e.g., 0.005 to 5 g/liter for PDADMAC, 1 to 5 g/liter for kappa-carrageenan and 0.1 to 2.5 5 g/liter for PVTC) to a suspension of the clay particles in water (e.g., an aqueous slurry with MMT concentration in the range from 1 to 30 g/liter, e.g., around 1-10 g/liter), stirring the resultant mixture (for example, over a few hours, e.g., 1 to 24 hours) usually at room temperature, separating the solid from the liquid phase (e.g., by filtration, decantation or centrifugation), washing the solid particles, drying (e.g., oven drying, freeze drying, air drying) and optionally reducing the particle size by milling to obtain ground particles and sieving to collect a population of particles with reduced particle size.

Accordingly, the invention further provides a process for preparing a composite adsorbent, comprising combining an aqueous solution of a polyelectrolyte and a suspension of montmorillonite-based clay in water, stirring the resultant mixture, separating the solid particles, washing, drying, reducing the particle size (e.g., in a conventional grinder) to obtain ground particles and optionally sieving the ground particles to collect a population of particles with reduced particle size.

For example, when the polyelectrolyte is poly(diallyl dimethyl ammonium chloride), then the stirring of the suspension is performed at high ionic strength created by the presence of a salt (sodium chloride) and the ratio between the polymer and montmorillonite-based clay is in the range of 1/5 to 1/160, e.g., 1/20 to 1/80, e.g., about 1/40.

To attain the desired amount of the polymer onto the clay while avoiding excessive masking of the mineral binding sites, the polymer is manipulated to acquire an extended configuration on the surface of the clay, also known by the name ‘loops & tails’ configuration (see FIG. 6, showing the difference between normal configuration (6a) and the ‘loops & tails’ configuration (6b-6c; see also Pierre Chodanowski and Serge Stoll, Macromolecules 2001, 34, 2320-2328). The configuration of the polymer on the surface of the clay and the degree of masking can be adjusted by the following process variables:
1) the polyelectrolyte: molecular weight and charge density of the polyelectrolyte are appropriately chosen (polymer grades with high molecular weight more readily assume the ‘loops & tails’ configuration, e.g., 400,000-500,000 g/mol for PDADMAC; low charge density polycation also favors the ‘loops & tails’ configuration).
2) the polyelectrolyte/clay ratio; the weight ratio between the solubilized polymer and the suspended clay is adjusted preferably in the range from 1/1 to 1/160, e.g., 1/5 to 1/160 (during preparation).
3) the ionic strength of the suspension/polymer solution, e.g., supplying the polymer to the clay suspension from a high ionic strength solution (e.g., 0.01 to 1.5M NaCl), favors the ‘loops & tails’ configuration. Composite adsorbent prepared in this manner are indicated by the abbreviation IS, for example, OH50PVP-MMT-IS.

As mentioned above, the particles of the neat MMT (before the adsorption/modification with the polyelectrolyte) are typically of size in the range of 1 to 10 μm. The particle size of composite adsorbent according to the invention is from 100 to 500 μm [median measured by laser granulometry particle size analyzer or by screening through a suitable mesh]. Usually, the particle size of the as-prepared composite adsorbent is from 200 to 400 μm (~300 μm; median by Malvern), whereas ground and sieved composite adsorbent (i.e., following milling/grinding and sieving) has particle size distribution (measured as explained above) with median in the range <300 μm, e.g., from 100 to 200 μm (passed through suitable meshes of 140 μm or 125 μm). Composite adsorbent prepared in this manner are indicated by the abbreviation FG, for example, PVTC-MMT-FG.

Specifically, oven-dried or freeze-dried, ground composite adsorbent having particle size distribution (median) in the range <300 μm, for example, consisting of particles passing through 125 μm or 140 μm meshes, which comprises:
MMT and poly(diallyl dimethyl ammonium), e.g., with 0.015 to 0.15 g polymer per gram of clay, e.g., 0.02 to 0.1 g polymer per gram clay, e.g., 0.02 to 0.05 g polymer per gram clay;
MMT and carrageenan, e.g., with 0.01 to 0.07 g polymer per gram of clay; or
MMT and poly(vinyl benzyl trimethylammonium), e.g., with 0.015 to 0.15 g polymer per gram of clay;
   were found to be effective in removal of undesirable constituents from beverages (e.g., haze-causing proteinaceous materials and/or ochratoxin A) and are preferred for use in the method of the invention.

To determine that a composite adsorbent possesses the desired degree of surface masking/‘loops & tails’ configuration, the following methods may be used:
1) trial-and-error experiments: adsorbent composites are prepared by combining the MMT suspension and the polymer solution at different MMT/polymer ratios, under varying ionic strength of the polymer solution, to produce a plurality of different composite adsorbents; each composite adsorbent is stirred in a test liquid (such as water) comprising a test agent to be removed (such as protein) for an appropriate duration; the suspended solid is allowed to settle out of the liquid, the sediment is separated, the loss of volume of test liquid is determined (i.e., liquid captured by the sediment) and the amount of test agent that has been removed is also measured. Then, a composite adsorbent showing an acceptable liquid loss alongside good removal rate of the undesired agent is selected. Such trial-and-error tests are shown in the experimental section below.
2) Pb²⁺ adsorption test: because the masking of the clay by the polymer is designedly partial, bare areas remain on the surface of the clay. These bare areas retain their negative charge characteristic of the neat MMT, and consequently, they possess adsorption capacity towards a metal cation. Thus, adsorption of Pb²⁺ by the modified MMT from an aqueous solution indicates the degree of surface masking. For example, for MMT with cation exchange capacity of 0.76 mmol/g, adsorption of 0.1 to 0.3 mmol Pb²⁺/g indicates an appropriate degree of surface masking.
3) Spectroscopic methods: changes in spectral features attest to the degree of surface masking. For example, FTIR spectrum of a neat polymer shows a characteristic peak. An FTIR spectrum of MMT that is fully masked with the polymer is produced, indicating a shift of the characteristic peak. The peak shift in the spectrum occurs due to interaction of the polymer with the surface of the clay and is assigned to the fully adsorbed state of the polymer, i.e., maximal interaction. The maximal shift is labeled Δ (e.g., Δ may extend over 5 to 10 cm⁻¹). An FTIR spectrum of the polymer with ‘loops & tails’ configuration on the surface of the clay, corresponding to the state of partial masking of the clay by the polymer, exhibits a smaller peak shift; a composite adsorbent for use in the invention generally shows IR peak shift of 0.3Δ to 0.7Δ.
4) X-ray diffraction: X-ray diffraction pattern of neat MMT shows a single dominant peak. In the XRPD of a fully masked clay (train configuration), the peak is slightly shifted. In the case where the polymer shows the ‘loops and tails’ configuration (partial masking), a major shift is observed, and the appearance of two peaks is expected, one assigned to a train configuration and the other to the ‘loops and tails’ configuration.

The composite adsorbent of the invention is used to treat beverages or other suitable liquids by adding the sorbent particles to a body of the liquid under stirring. The dose of the adsorbent is preferably from 0.1 to 2 g/liter of the liquid to be treated, e.g., from 0.5 to 1.5 g/liter. A suitable duration of contact is not less than 1 hour, usually from one to seven days, depending on the liquid to be treated and dose applied.

The composite adsorbent is readily separable from the liquid as the sedimentation of the particles occurs fairly quickly owing to their relatively large particle size (the surface modification with the polymer results in an increase of two orders of magnitude in particle size compared to the neat clay). The composite adsorbent can be separated from the treated liquid shortly after the stirring of the suspension is stopped and sedimentation occurs, by filtration, decantation, and centrifugation.

Another method to treat the liquid is by passing the liquid through a fixed bed of the adsorbent e.g., disposed on a suitable screen or through a bed of adsorbent, after it has been shaped into a suitable physical form, e.g., granules. For example, granular PDADMAC-MMT is described in US 2022/0402799.

The composite adsorbent of the invention is effective in removing undesirable constituents from weakly acidic or moderately acidic aqueous beverages (e.g., 2.5≤pH≤5; 3≤pH≤4). Haze-forming proteins can be removed from beers, wines and beverages containing fruit extracts, e.g., grape juice and clarified grape juice, citrous juice and apple juice.

The experimental results reported below indicate that composite adsorbents of the invention have many benefits (especially oven-dried or freeze-dried composite adsorbents with reduced particle size, i.e., where the as-prepared composite adsorbent undergoes drying and subsequent milling and sieving (through 100 mesh, <149 μm or 120 mesh, <125 μm). The ground material has particle size distribution with median (Malvern analyzer) in the range <300 μm, e.g., from 100 to 200 μm. The chemical modification of the clay surface by suitable polyelectrolytes and selection of particle size distribution can offer a good control over the removal of undesirable constituents from the beverage and minimization of the loss of beverage to the swelling adsorbent (i.e., reduced sediment volume) to meet commercial demands. That is, in some cases, it is important to lose as little volume of the beverage as possible, whereas in other cases, it is important to remove as much of the undesired agent even if more beverage is trapped by the clay (the trapped beverage is recoverable and has commercial value).

For example, with respect to removal of OTA, as mentioned above, bentonite (BT), commercial MMT, is commonly used as a fining agent in the wine industry. But OTA adsorption by BT from red wine (using 0.6-1 g/L BT) was ~8-31% (see Kurtbay, supra) whereas adsorbent composite of the invention has shown ~60% adsorption under similar conditions, e.g., PVTC-MMT-FG (the letters FG indicate ground material). At the moderately acidic pH of the beverage, OTA exists in two forms: deprotonated (anionic) and protonated (nonionic) forms. The nonionic OTA may adsorb to the bare siloxane surfaces in the partially masked composite adsorbent and may also interact with the polymer via hydrophobic and/or n-n interactions. These interactions along with electrostatic interactions of the anionic OTA, with the cationic polymer applied onto the surface of the clay, account for the high adsorption to the composite adsorbent. Finally, even though MMT has higher surface area than the composite adsorbent, it is clear that the chemical composition of the sorbent is much more significant than the sorbent surface area in terms of OTA adsorption.

Another useful property of the composite adsorbent of the invention resides in its reduced liquid uptake compared to neat MMT/BT. MMT/BT are well known as swelling clays, mainly when the exchangeable cation is sodium, holding more than 100 w/w and therefore it is not surprising that a large volume of beverage such as grape juice can be held within these clays. However, upon modification of the clays by exchanging the sodium cation, swelling is reduced. Furthermore, MMT and BT platelets are negatively charged with repulsion forces, which cause an increase in general volume. On the other hand, the composite adsorbent is positively charged (indicated by zeta potential) but possesses negatively charged patches (bare clay surfaces), enabling a more condensed arrangement with less beverage trapped in the sediment.

The significantly smaller loss of the beverage (e.g., grape juice) to the composite adsorbent in comparison to the loss to neat BT can be of great importance to the wine and grape juice industry, as large quantities of liquid which are regularly being lost to the BT sediment and often discarded/recovered by additional steps, can potentially be saved by applying the composite adsorbents of the invention for fining.

Thus, adsorbent composites (also named herein CPNs) were developed, characterized, and tested, to optimize OTA treatment, adsorption, and CPN-OTA removal by sedimentation, while maintaining product quality. OTA adsorption, to MMT and developed CPNs, was optimized based on polymer chemical or configuration diversity, and studied from water with increasing complexity (varying pH and electric conductivity) and modeled.

Specifically, composite adsorbents were developed based on the adsorption to MMT of two polycations, OH50PVP and PVTC, which differ chemically but have similar functional groups, aromatic ring, and quaternary nitrogen, identified as the main binding sites for anionic organic molecules. ‘Loops & tails’ configuration was induced by synthesizing and adsorbing the low charge density OHPVP, OH50PVP. To further enhance a ‘loops & tails’ configuration we not only employed the low charge density polycation, OH50PVP, but also adsorbed it from a high IS solution (OH50PVP-MMT-IS). Also, we studied and compared the adsorption of OTA by two CPNs that differ chemically but with the same polymer loading (0.12±0.02 g polymer/g MMT), OH50PVP-MMT and PVTC-MMT, and two CPNs which differ in their physical configuration, OH50PVP-MMT and OH50PVP-MMT-IS.

As shown below, OTA kinetics adsorption and adsorption at equilibrium, to three specifically developed CPNs, based on polymer chemical or configuration diversity, was studied from water with increasing complexity (varying pH and EC). OTA adsorption rate and adsorption at equilibrium were the fastest and highest by the PVTC-MMT CPN. Despite the larger particle size of the ground PVTC-FG CPN, (particle size 125 μm) in comparison to that of MMT (3 μm), OTA adsorption from grape juice was nearly three times higher by the CPN. The low OTA adsorption from grape juice (pH=3.7) to the MMT is attributed to partial adsorption of the nonionic OTA, to siloxane surfaces, while for the CPN, nonionic OTA adsorbs to the bare siloxane but nonionic, as well as the anionic OTA, may also interact with the polycation, accounting for the higher adsorption to the CPN. CPNs outperformed or were as good as the clays (MMT/BT), in terms of maintaining grape juice product quality; pH, sugar CI and TPI. Although upon application of clays or the CPNs, turbidity (after 24 hours) was the same as the control (GJ), CPN sedimentation from GJ, was clearly advantageous compared to MMT and BT, in terms of sedimentation rate (2-4 orders of magnitude faster) and grape juice volume loss to sediment (an order of magnitude less). These findings demonstrate the advantage and applicability of CPNs for treating OTA-contaminated grape juice. Experimental work conducted in support of this invention shows that adsorbent composites, e.g.:

oven-dried or freeze-dried, ground and sieved PDADMAC-MMT; and oven-dried or freeze-dried, ground and sieved K-carrageenan-MMT; are effective in removing haze-forming proteins, meeting the requirements of the commonly used heat stability test. After treatment, the change is turbidity following heating to 80° C. for two hours is less than 2 NTU, indicating that a significant portion of the haze-forming proteins has been removed during the treatment, achieving heat stable product (stability against haziness formation during storage etc.).

### BRIEF DESCRIPTION OF THE DRAWINGS

FIG. 1A shows FTIR spectra of OH50PVP, OH50PVP-MMT and OH50PVP-MMT-IS (0.12 g and 0.65 g polymer/g MMT, respectively).

FIG. 1B is a graph of lead adsorption isotherm to OH50PVP-MMT and OH50PVP-MMT-IS (0.12 g and 0.65 g polymer/g MMT, respectively) (1 g/L).

FIG. 2A is a graph of PVTC adsorption (0.056-1.67 g polymer/g MMT) isotherm to MMT and zeta potential (STD between 1.48-20.21 mV) of the CPNs.

FIG. 2B is a diffractogram of MMT and PVTC-MMT CPN.

FIG. 2C shows particle size distribution curves (BT, MMT, PVTC-MMT and PVTC-MMT-FG).

FIG. 3A is a graph of adsorption isotherms of OTA (0-18000 μg/L) to PVTC-MMT, OH50PVP-MMT and OH50PVP-MMT-IS.

FIG. 3B is a graph of adsorption isotherms of OTA (0-18000 μg/L) to PVTC-MMT, OH50PVP-MMT and MMT.

FIG. 3C shows OTA adsorption versus time plots, i.e., kinetics of OTA (50 μg/L) adsorption by PVTC-MMT and OH50PVP-MMT (1 g/L) from DDW, DDW+pH (DDW at low pH) and DDW+pH+EC (DDW at low pH and high EC).

FIG. 3D is a bar diagram of OTA (15 μg/L) adsorption by PVTC-MMT and MMT (1 g/L) from DDW, DDW+pH (DDW at low pH), DDW+EC (DDW at high EC), DDW+pH+EC (DDW at low pH and high EC) and GJ at equilibrium.

FIG. 4A is a bar diagram of OTA (15 μg/L) adsorption from GJ by PVTC-MMT, PVTC-MMT-FG and MMT using increasing concentrations (1-10 g/L) after 2 hours.

FIG. 4B is a bar diagram of OTA (15 μg/L) adsorption from GJ by PVTC-MMT, PVTC-MMT-FG and MMT using concentration of 3 g/L after 2, 8 and 24 hours.

FIG. 5A is a diagram showing the sedimentation rate of the sorbents and turbidity for GJ within 24 hours.

FIG. 5B is a diagram of GJ volume loss to sorbent sediment.

FIG. 6 shows various configurations of polymer on clay surface.

### EXAMPLES

### Materials

Wyoming Na-montmorillonite SWy-2 (MMT), with a cation exchange capacity (CEC) of 76.4 cmol/kg and BET specific surface area of 756 m²/g, was obtained from the Source Clays Repository of the Clay Mineral Society (Columbia, MO). Bentonite (BT) was purchased from American Colloid Company.

Ochratoxin A (OTA), with ≥98% purity by HPLC, was purchased from Petromyces Albertensis.

2-bromo ethanol, ethanol, phosphate buffered saline (0.01 M—NaCl 0.138 M; KCl—0.0027 M; pH 7.4), sodium acetate anhydrous ≥98%, methanol, NaCl, acetic acid and acetonitrile were purchased from Sigma-Aldrich. PbCl₂ was purchased from Holland Moran.

Poly (vinylbenzyl trimethyl ammonium chloride) (PVBTMAC) ~100,000 Molecular Weight, 26.90% solids in water was purchased from Scientific Polymer Products Inc. Poly(4-vinylpyridine) (60,000 Da) was purchased from Sigma-Aldrich. Poly(diallyl dimethyl ammonium chloride) (PDADMAC) (average Mw 400,000-500,000 Da) was purchased from Sigma-Aldrich. K-Carrageenan (derived from edible red algae) was purchased from Glentham Life Sciences.

Ochraprep Immunoaffinity columns (IAC) were purchased from R-Biopharm.

Red grape juice and red must after commercial crushing (Cabernet Sauvignon, 2020) were received from the “Geshem” vineyard (Dalton, Israel).

### Methods

### 1) CPNs Characterization:

### A) Element Analysis

Loading of PVTC and OH50PVP was quantified by element analysis of % C in the CPN. An adsorption isotherm of PVTC (0.056-1.67 g polymer/g MMT) on MMT (1.67 g/L) was prepared. The analysis was performed on Fisons, EA 1108, Waltham, MA, USA.

### B) UV-Vis Spectrophotometry

UV-vis spectra were recorded by a UV-vis diode-array HP 5482A spectrophotometer. To verify the mass balance, the polymer concentration in the supernatant (not adsorbed) was measured by a UV-vis spectrophotometer at 261 nm for PVTC and 230 nm for OH50PVP.

Also, to measure possible desorption of the polymer PVTC from the CPN, PVTC-MMT was added (1 g/L) to DW and DW at pH=3.7 and EC=2.04 mS/cm (similar values to GJ) by adding acetic acid and sodium chloride and stirring for 60 min. The supernatant was separated from CPNs by running the solution through a PTFE syringe filter (AXIVA) with 0.45 μm pore size and measured by a UV-vis spectrophotometer at 261 nm.

### C) Fourier Transform Infrared Spectroscopy (FTIR)

FTIR spectra were obtained by FTIR spectrometer (Nicolet Magna-IR-550, Madison WI) and were used to validate the configuration of the OH50PVP-MMT-IS CPN.

### D) Inductively Coupled Plasma Optical Emission Spectrometry (ICP OES)

Axial ICP OES was performed on an ARCOS spectrometer (Spectro GmbH, Kleve, Germany) and used for the detection of a divalent cation (lead, Pb²⁺) [10 to 1200 ppm PbCl₂ salt solution was added to 1.5-3 g/l suspension of the composite adsorbent, the mixture was stirred for a few hours, the solid was separated by centrifugation and supernatant was measured for Pb²⁺ concentration in ICP OES)].

### E) Zeta Potential

The Zeta potential of the sorbents, CPNs and MMT, was measured using a Zetasizer Nanosystem (Malvern Instruments, Southborough, MA) in a dilute suspension.

### F) X-Ray Powder Diffraction (XRD)

XRD measurements (d001-value) of sorbents were performed on the D8 Advance diffractometer with the primary TRIO optic and the LynxEye XE-T High-Resolution Position Sensitive Detector (Bruker AXS, Karlsruhe, Germany). XRD patterns from 3° to 30° 2θ were recorded in the Bragg-Brentano geometry at room temperature using CuKα radiation (λ=0.15418 nm) with the following measurement conditions: tube voltage of 40 kV, tube current of 40 mA, step scan mode with a step size of 0.02° 2θ and a counting time of 1 s per step. Also, to identify the swelling minerals of the montmorillonite group, XRD patterns of the samples saturated with an alcoholic solution of glycerol were recorded.

### G) Size Distribution

To determine and compare size distributions, sorbents were measured using laser granulometry (Malvern Mastersizer 3000) (20 W).

### 2) Grape Juice (GJ) Quality:

To ensure GJ quality post sorbent treatment, sorbents were added (1-10 g/L) to GJ and the mixtures were shaken for 2 hours. The sorbents and supernatants were separated by filtration or centrifugation, and then tested for the following properties:

### A) pH

pH was measured during all procedures to evaluate the effect on acidity.

### B) Color Intensity (CI)

CI was determined from the sum of absorption intensities of diluted samples 1:1 (v/v) at 420, 520 and 620 nm, following the official methods prescribed by European Commission Regulation No. 2676/90 (European Economic Community (EEC) 1990) [“Determining Community Methods for the Analysis of Wines”, Off. J. L., 1990, 272, 1-192.]

### C) Total Polyphenol Index (TPI)

TPI was determined by measuring the absorption of diluted samples 1:20 (v/v) at 280 nm.

### D) Total Sugar Concentration

Total sugar concentration was measured by HPLC using a Refractive Index (RI). A total of five different sugar molecules (Ketose, Sucrose, Glucose, Fructose, and Sorbitol) were tested, and total concentrations were quantified.

3) OTA-Sorbent Complex Removal from GJ

The technique for OTA-sorbent complex removal was by sedimentation. Sedimentation rate, liquid turbidity and GJ volume loss due to sedimentation were determined. To evaluate sedimentation rate and liquid clarification, sorbents (PVTC-MMT, PVTC-MMT-FG, MMT, and BT), were added to GJ (3 g/L) and Turbid-GJ (1 g/L), shaken for 2 hours, and then measured for turbidity. Measurements were collected for 48 hours (data shown until 24 hours) in various time intervals using a turbidity meter.

### A) Sedimentation Rate

Sedimentation rate was calculated using Stock's law:

$$V = \frac{2}{9} \times \frac{( {d}_{b} - {d}_{w} ) \times ℊ \times {r}^{2}}{η}$$

where d_{b} is the particle density determined as 2.65 g/cm³ (consented value for clay's particle density), d_{W} is liquid density (grape juice, 1.09 g/ml), g is Gravitational acceleration (980 cm/s²), η is liquid viscosity determined as 0.017 Poise (calculated viscosity from grape juice temperature and Brix) and r is particle radius, corresponding to the median particle size extracted from size distribution measurements.

### B) Turbidity

Turbidity was measured using a turbidity meter (MRC, TU-2016, Holon, Israel).

### C) GJ Volume Loss

To quantify GJ loss to sorbent's (PVTC-MMT, PVTC-MMT-FG, MMT, and BT) (3 g/L) sediment, supernatant volume was measured at the end of sedimentation (24 hours) and compared to initial volume.

### 4) OTA Quantification

### A) OTA Adsorption by Sorbents

Sorbents (OH50PVP-MMT, PVTC-MMT, PVTC-MMT-FG and MMT) were added (1-10 g/L) to OTA solutions. The OTA-sorbent suspensions were separated from the solutions by filtration (kinetics), or centrifugation. To measure OTA in GJ, OTA was first eluted from the supernatant using IACs. OTA concentrations in the supernatants were quantified by HPLC.
A1. OTA removal (0-18000 μg/L) from double distilled water (DDW) was measured at equilibrium (agitated for 1 hour) and fitted to the Langmuir model.
A2. The kinetics of OTA removal (50 μg/L) was measured at time intervals varying from 1 to 20 min from three different mediums: double distilled water at pH=5.6 and EC=0.0008 mS/cm (DDW), double distilled water at pH=3.7 by adding acetic acid (DDW+pH), and double distilled water at pH=3.7 and EC=16.16 mS/cm by adding acetic acid and sodium chloride or sodium acetate (DDW+pH+EC). The kinetics of adsorption was analyzed by the differential form of the Langmuir adsorption model.
A3. To compare CPN and MMT adsorption performance, PVTC-MMT and MMT (1 g/L) were added to OTA (15 μg/L) solutions with increasing complexity. Adsorption was measured after 1 hour (water with increasing complexity) and 2 hours (GJ) agitation. Solutions were DDW, DDW+pH, double distilled water at pH=5.7 and EC=16.16 mS/cm by adding sodium chloride (DDW+EC), DDW+pH+EC and GJ.
A4. Sorbents (PVTC-MMT, 500HPVP-MMT and MMT) were added (1-10 g/L) to GJ, spiked with 15 μg/L of OTA (shaken for 2, 8 and 24 hours). OTA was eluted from the supernatant using IACs and measured by HPLC.

Measurements in GJ were made in duplicates, all other measurements were made in triplicates.

### Preparations 1-2

### Preparations of Grape Juice

### 1) Turbid Grape Juice (Turbid GJ)

Commercially crushed red must was treated by an enzyme (pectinase 0.067 mg/L) and by sulfite (100 mg/L). The must was stored for 9 days at 4° C., and the formed juice was drained off the pomace and pressed to extract the juice remaining in the matrix.

### 2) Clear Grape Juice (GJ)

The turbid grape juice from preparation 1 was centrifuged at 4000 rpm for 10 min, and the supernatant collected was extracted to obtain clear grape juice (GJ). The GJ was stored at −20° C. and defrosted as needed (it was used for most experiments).

### Example 1 (Comparative) and 2 (of the Invention) Preparation of a Composite Adsorbent Using MMT and the Polymer Poly-4-Vinyl(1-(2-Hydroxyethyl)Pyridinium Bromide

Poly-4-vinyl(1-(2-hydroxyethyl) pyridinium bromide with substitution level of 50% (OH50PVP) was synthesized according to the procedure reported by Levy et al. (supra) Freeze-dried poly-4-vinylpyridine (PVP), 50 g/L, was solubilized in ethanol for 24 h. Bromoethanol was added at a 1:2 molar ratio relative to the pyridine groups and the reaction mixture was refluxed for 2 h at 80° C. The solvent was removed under reduced pressure to obtain OH50PVP, which was used to prepare two types of montmorillonite-polymer composite adsorbents:

### 1) OH50PVP-MMT Composite Adsorbent (OH50PVP-MMT CPN)

The procedure was reported by Levy et al. (supra). Solutions of OH50PVP with concentrations in the range from 0.083-2.50 g/L were added slowly to MMT suspensions (5 g/L) to obtain final concentrations of 0.056-1.67 g/L of the polymer and 1.67 g/L of MMT, and the resulting clay-polymer suspensions were stirred overnight. The suspensions were filtered on a 12 μm filter under vacuum, to collect the CPNs and the supernatant. CPNs were washed with deionized water and filtered again. CPNs were freeze-dried and grinded.

### 2) OH50PVP-MMT Ionic Strength Composite Adsorbent (OH50PVP-MMT-IS CPN)

The procedure was reported by Shabtai et al. (supra). Solutions of OH50PVP with concentrations in the range from 0.083-2.50 g/L and 1.5M NaCl were prepared. After the addition of the resulting solutions to MMT suspensions (5 g/L), a final concentration of 1M of NaCl in the suspension was reached. Work-up by the procedure described above gave the resulting OH50PVP-MMT-IS CPN with an extended configuration of ‘Loops & tails’ and high polymer loading.

### Example 3

### Preparation of a Composite Adsorbent Using MMT and the Polymer Poly(Vinylbenzyl Trimethyl Ammonium Chloride)

Solutions of poly(vinylbenzyl trimethyl ammonium chloride) with concentrations in the range from 0.083-2.50 g/L were added slowly to MMT suspensions (5 g/L) to obtain final concentrations of 0.056-1.67 g/L of the polymer and 1.67 g/L of MMT, and the resulting clay-polymer suspensions were stirred overnight. The suspensions were filtered on a 12 μm filter under vacuum, to collect the CPNs and the supernatant. CPNs were washed with deionized water and filtered again. CPNs were freeze-dried.

### Example 4

### Preparation of a Composite Adsorbent Using MMT and the Polymer Poly(Vinylbenzyl Trimethyl Ammonium Chloride)

The procedure of Example 3 was repeated, but the particles were further ground and sieved <140 μm (mesh). This grade, consisting of ground and sieved CPNs, is named herein PVTC-MMT-FG CPN.

### Example 5

### Characterization of the Composite Adsorbent OH50PVP-MMT

The effect of OH50PVP loading on pollutant adsorption was examined for the CPNs of Example 1. CPN with loading of 0.12±0.02 g polymer/g MMT (collected from a suspension consisting of 0.33 g/L polymer and 1.67 g/L MMT) was found optimal based on its zeta potential.

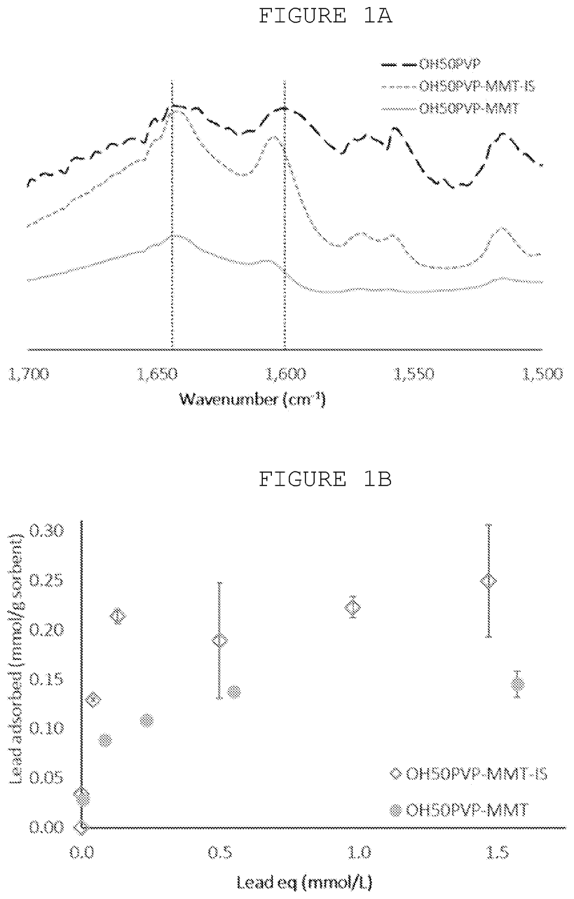

The corresponding suspension consisting of 0.33 g/L polymer and 1.67 g/L MMT, prepared according to Example 2 (where the polymer was supplied from high ionic strength NaCl solution), afforded CPN with significantly higher polymer loading of 0.65 g polymer/g MMT, suggesting an enhanced configuration of ‘loops & tails’. The FTIR spectra of the neat polymer OH50PVP, OH50PVP-MMT of Example 1 and OH50PVP-MMT-IS of Example 2 are shown in FIG. 1A and characteristic peaks are tabulated in Table 1. Two main peaks were observed for the neat polymer OH50PVP, at 1644 and 1600 cm⁻¹, assigned to the pyridinium and pyridine groups, respectively, with a shift in the pyridine peak upon polycation adsorption to the clay in the OH50PVP-MMT CPN, indicating an interaction of the polymer with the clay surface. A less pronounced shift was obtained for the OH50PVP-MMT-IS of Example 2, indicating lesser interaction of the polymer with the surface of the clay, in line with an enhanced ‘loops & tails’ configuration.

TABLE 1

| | | OH50PVP-MMT | OH50PVP-MMT-IS |
|---|---|---|---|
| | Neat | Example 1) | (Example 2) |
| | polymer | (0.12 ± 0.02 g | 0.65 g polymer |
| | OH50PVP | polymer per g | per g MMT |
| | cm⁻¹ | MMT cm⁻¹ | cm⁻¹ |
| Pyridine groups | 1600 | 1607 | 1604 |
| Pyridinium groups | 1644 | 1642 | 1642 |

FIG. 1B lends further support to the enhanced ‘loops & tails’ configuration with extensive exposed clay surface in the case of OH50PVP-MMT-IS, showing higher adsorption capacity of OH50PVP-MMT-IS towards divalent lead cation compared to OH50PVP-MMT (over Pb²⁺ concentration range of 0.03 to 4.12 mmol/L, at 1 g/L sorbent concentration). The adsorption coefficients calculated from the Langmuir equation are tabulated in Table 2 (Qₘₐₓ is the adsorption capacity and K_{L} is the affinity coefficient).

TABLE 2

| | Qₘₐₓ, | K_{L}, | |
|---|---|---|---|
| CPN | mmol/g | L/mmol | R² |
| OH50PVP-MMT-IS | 0.23 | 34 | 0.95 |
| of Example 2 | | | |
| OH50PVP-MMT | 0.14 | 21 | 0.98 |
| of Example 1 | | | |

### Example 6

### Characterization of the Composite Adsorbent PVTC-MMT

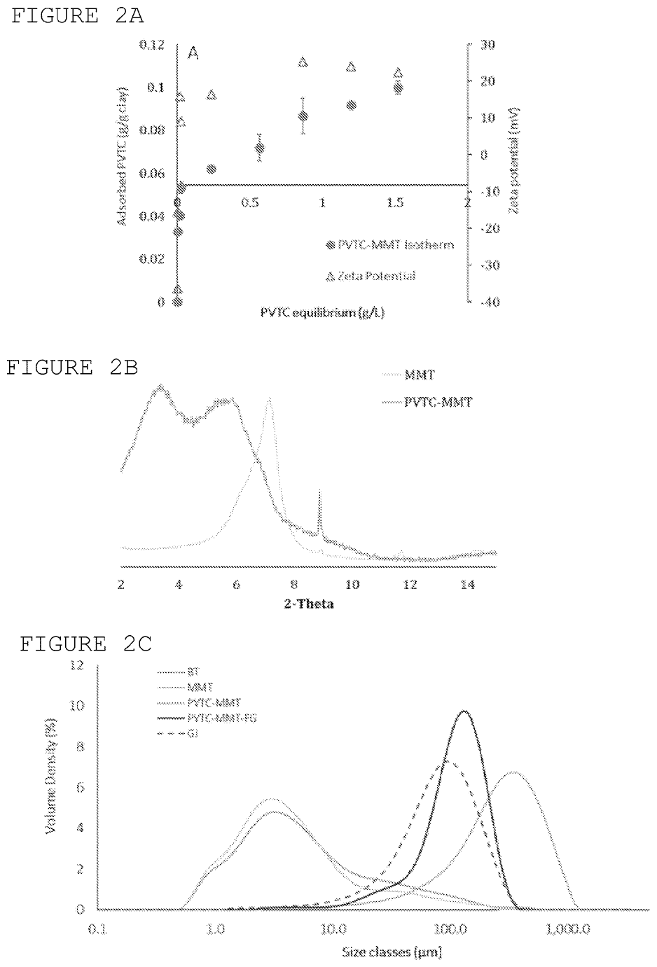

The loading of PVTC onto MMT, by addition of 0.06-1.67 g/L polymer to 1.67 g/L MMT suspension (Example 3) was quantified and the corresponding CPN zeta potentials were measured. In FIG. 2A, the abscissa indicates the added concentration of PVTC, the left ordinate is the corresponding loading of the polymer onto the MMT (g polymer per g clay), and the right ordinate is the measured zeta potential.

It is seen that upon increasing the added PVTC concentration, loading is increased, accompanied by an increase in zeta potential from a negative value for MMT, with charge reversal obtained at a very low loading of 0.062 g polymer/g MMT and a positive zeta potential value for a CPN with a loading of 0.12±0.02 g polymer/g MMT. As obtained for OH50PVP-MMT (0.12±0.02 g polymer/g MMT) the basal spacing of MMT 1.24 nm increased with two broad peaks recorded at 1.51 and at 2.62 nm (FIG. 2B), indicating PVTC intercalation. The first peak can be associated with a ‘train’ configuration whereas the second peak, indicating a large spacing, represents an extended configuration such as ‘loops & tails’.

PVTC desorption was very low, 0.8±0.3% from DW, in agreement with the desorption of OH50PVP. The particle size distributions of the neat clays, namely, MMT and BT, and the PVTC-MMT CPN of Examples 3 and 4 are plotted in FIG. 2C, indicating a median particle size of 300 μm for the PVTC-MMT CPN of Example 3, which is two orders of magnitudes larger than the median particle size of neat MMT and BT (4 μm), emphasizing the significantly lower surface area of the CPN.

### Example 7

### Adsorption of OTA from Water and Aqueous Solutions

The adsorption of OTA by neat NMT and the CPNs of Examples 1 and 3, which differ chemically and/or in their physical configuration, was studied.

The composite adsorbents of Example 1 (OH50PVP-MMT CPN) and Example 3 (PVTC-MMT CPN) as well as MMT were added (at concentration of 1 g/L) to OTA solutions in double distilled water (OTA concentration of 15 μg/L) with different complexity. The OTA-sorbent suspensions were stirred and separated by filtration (for kinetics measurements) or by centrifugation.

The adsorption was measured at equilibrium after 1 h agitation. All the measurements were performed in triplicates.

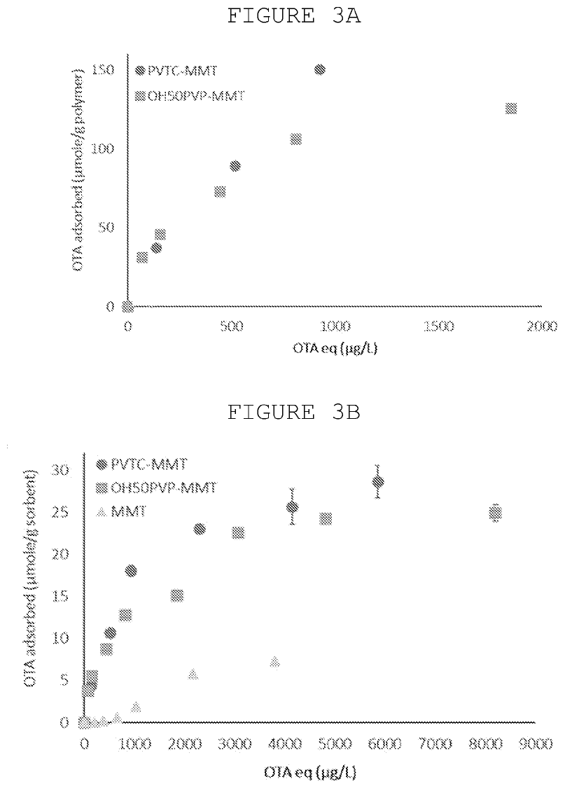

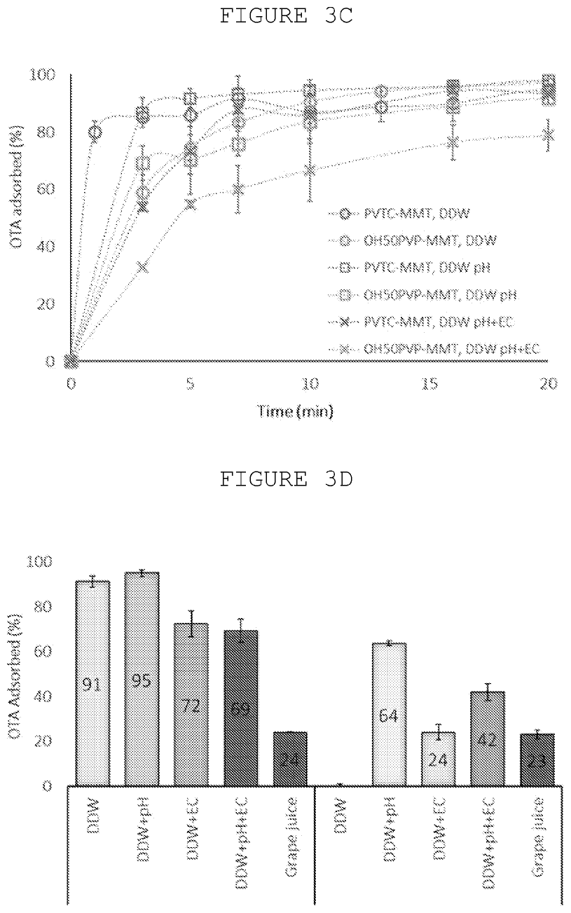

FIG. 3A is a graph of adsorption isotherms of OTA (0-18000 μg/L) to OH50PVP-MMT (Example 1) and PVTC-MMT (Example 3). The sorbents were used at a concentration of 1 g/L, and the adsorption is normalized to polymer loading, i.e., per one g polymer.

The adsorption isotherms of OTA (0-18000 ppb) from DDW by PVTC-MMT, OH50PVP-MMT and MMT are shown in FIG. 3B and fitted to the Langmuir adsorption model. Adsorption coefficients calculated from the Langmuir equation (Qₘₐₓ—adsorption capacity; K_{L}— affinity coefficient) are tabulated in Table 3.

TABLE 3

| | Qₘₐₓ, | K_{L}, | |
|---|---|---|---|
| CPN | mmol/g | L/mmol | R² |
| PVTC-MMT | 0.032 | 461 | 0.99 |
| OH50PVP-MMT | 0.028 | 407 | 0.97 |
| MMT | 0.012 | 105 | 0.90 |

It is seen that the OTA adsorption to MMT was very low at low OTA concentrations but increased to some degree at extremely high concentrations, resulting in an S-shape isotherm. The adsorption capacity of PVTC-MMT (Qₘₐₓ=0.032 mmol/g and affinity K_{L}=461 L/mmol) was high and similar to OH50PVP-MMT (Qₘₐₓ=0.028 mmol/g, K_{L}=407 L/mmol). OTA is mainly anionic (pKa=4.4) at pH 5.7 (DDW), while the CPNs have a positive zeta potential, indicating electrostatic interactions. Important to note, that OTA concentrations found in food products generally and GJ and wine specifically are significantly lower (~1-7 ppb).

FIG. 3C shows OTA adsorption percentage versus time curves, measured over twenty minutes. The sorbents PVTC-MMT and OH50PVP-MMT were tested in different solutions. In DDW, the kinetics of OTA (50 ppb) adsorption by PVTC-MMT and OH50PVP-MMT was high and fast in both cases, reaching ~90% within 10 minutes (FIG. 3C, blue and orange circles, respectively). The adsorption (forward kinetic adsorption coefficient C) and desorption (kinetic desorption coefficient D) coefficients, which can describe the adsorption affinity coefficient (K=C/D), were determined by relating the data from the kinetic experiments to the time-dependent Langmuir equation. The adsorption coefficient (C) of PVTC-MMT was five times higher than that of OH50PVP-MMT while the desorption coefficient (D) was also higher resulting in similar K values for both CPNs (Table 4; the kinetic coefficients calculated from the Langmuir equation include R₀—molar concentration of adsorbent surface sites, C—forward kinetic adsorption coefficient and D—kinetic desorption coefficient)). These values well fit the affinity coefficients calculated from the adsorption isotherms.

TABLE 4

| | R₀, | C, | D, | |
|---|---|---|---|---|
| CPN | mole/L | L/mole*min | 1/min | R² |
| PVTC-MMT | 3.2 × 10-5 | 45000 | 0.10 | 0.96 |
| OH50PVP-MMT | 2.8 × 10-5 | 9500 | 0.01 | 0.99 |

Upon increasing solution complexity, DDW+pH (pH=3.7, typical GJ) and DDW+pH+EC (pH=3.7, EC=16.16 mS/cm) OTA adsorption to PVTC-MMT at equilibrium was not compromised while the kinetics was only slightly compromised in the latter case. The kinetics of OTA adsorption to OH50PVP-MMT was slower from all solutions. Moreover, OTA adsorption to OH50PVP-MMT from ‘DDW+pH+EC’ (pH=3.7, EC=16.16 mS/cm) was slower and lower than from DDW. The reduced OTA adsorption from ‘DDW+pH+EC’ is most likely attributed to high IS which reduces electrostatic attraction by screening OTA-sorbent interactions. Based on the advantages of PVTC-MMT, it was selected for further study of its performance, i.e., OTA adsorption from DDW solutions, with increasing complexity, and GJ.

The adsorption of OTA (15 μg/L), from various solutions, by PVTC-MMT was compared to its adsorption by MMT, which is applied in a commercial product as an oenological agent. The results are shown in the form of a bar diagram in FIG. 3D. It is seen that OTA adsorption from DDW to PVTC-MMT was very high while negligible to MMT (0±0.9%), due to electrostatic attraction and repulsion, respectively. Upon lowering the pH to 3.7, adsorption to PVTC-MMT did not change, but it was increased dramatically to MMT, reaching 63.7±1.0%. The repulsion of OTA (pKa=4.4) to the negatively charged MMT was reduced at this low pH, increasing OTA adsorption.

Upon increasing the solution EC (pH remained 5.6), OTA adsorption to PVTC-MMT was slightly decreased, and increased to MMT, due to electrostatic attraction and repulsion screening, respectively. The adsorption of OTA from a DDW solution of both low pH and high EC resulted in a combination of both effects, to the sorbents. Finally, OTA adsorption was affected by pH and EC but not only.

### Example 8

### Adsorption of OTA from Grape Juice (GJ)

Composite adsorbents (MMT, PVTC-MMT of Example 3 and PVTC-MMT-FG of Example 4) were tested for their ability to remove OTA from grape juice. The sorbents were added at concentrations of 1, 3, 5 and 10 g/L to grape juice, spiked with 15 μg/L of OTA, and OTA adsorption was determined after shaking for 2, 8 and 24 hours. To measure OTA in grape juice, OTA was first eluted from the supernatant using IACs and OTA concentrations in the supernatants were quantified by HPLC. Measurements in grape juice were made in duplicates.

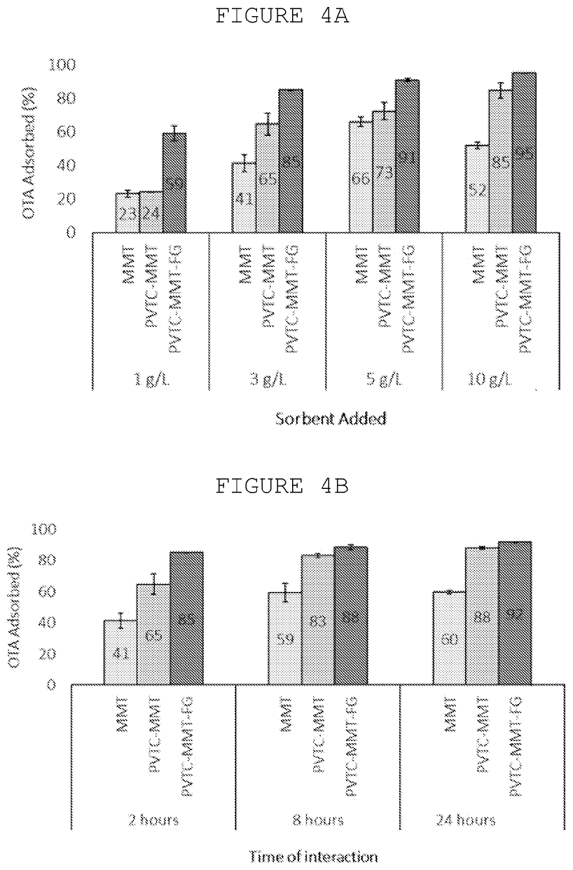

The results are shown in FIG. 4A in the form of a bar diagram. Four groups of bars are shown, corresponding to the four concentrations of sorbent tested (1, 3, 5 and 10 g/L), with each group consisting of three bars corresponding to the three sorbents tested: MMT, PVTC-MMT and PVTC-MMT-FG.

The median particle size of MMT is 4 μm. The median particle size of PVTC-MMT is two orders of magnitude larger (300 μm), while PVTC-MMT-FG is a reduced particle size composite adsorbent obtained by grinding PVTC-MMT and sieving, collecting particles smaller than 125 μm, to increase the surface area compared to PVTC-MMT. Even though the CPN particle size of PVTC-MMT was reduced by half only upon grinding, the adsorption of OTA to PVTC-MMT-FG was three times higher (59.1±4.5% vs. 24.3±0.1% for PVTC-MMT, at sorbent concentration of 1 g/L).

The adsorption of OTA to MMT, PVTC-MMT and PVTC-MMT-FG increased with increasing CPN concentration from 1 to 10 g/L. However, the efficiency 1 g/L was the highest reaching an adsorption of 23.1±1.9, 24.3±0.1 and 59.1±4.5% to MMT, PVTC-MMT and PVTC-MMT-FG, respectively (efficiency is determined as amount of OTA removed per one gram sorbent). Comparing the three sorbents, PVTC-MMT showed higher adsorption percentage than MMT using 3 g/L and above, while PVTC-MMT-FG showed the highest OTA removal percentage in all concentrations due to its higher surface area.

Moreover, as shown in FIG. 4B, increasing interaction time of sorbents (applied at 3 g/L) with GJ resulted in higher adsorption of OTA to MMT, PVTC-MMT and PVTC-MMT-FG from 41±4.9, 65±6.6, and 85±0.1% after 2 hours, to 60±1.2, 88±0.7, and 92±0.1% after 24 hours, respectively.

OTA (pKa=4.4) in GJ (pH=3.5) is mainly in a protonated (nonionic) form and approximately 20% of the molecules are deprotonated (anionic). It is postulated that the low adsorption to the negatively charged MMT is attributed only to partial adsorption of the nonionic OTA, most likely to the siloxane surfaces. While nonionic OTA may also adsorb to the bare siloxane surfaces in the CPN, they may also interact with the polymer via hydrophobic and/or n-n interactions. These interactions along with electrostatic interactions of the anionic OTA, with the cationic polymer, account for the high adsorption to the CPN. Finally, even though MMT has the highest surface area, it is clear that the chemical composition of the sorbent is much more significant than the sorbent surface area in terms of OTA adsorption.

### Example 9

### The Effect of Sorbent on GJ Parameters

The effect of sorbent application for OTA treatment, adsorption, and removal, on GJ parameters were examined to ensure that product quality is not compromised.

Sorbents were added (1-10 g/L) to GJ (Preparation 2) and shaken for 2 hours. The sorbents and supernatants were separated by filtration or centrifugation, and the following properties were determined: pH, color intensity (CI), total phenolic index (TPI) and total sugar concentration. The results are tabulated in Table 5.

TABLE 5

| | | | | Total Sugar |
|---|---|---|---|---|
| Sorbent | pH | CI (A.U) | TPI (A.U) | (g/100 ml) |
| PVTC-MMT | 3.63 ± 0.01 | 2.61 ± 0.02 | 1.22 ± 0.05 | 16.20 ± 0.09 |
| MMT | 3.65 ± 0.00 | 1.75 ± 0.09 | 1.15 ± 0.04 | 16.20 ± 0.10 |
| BT | 3.65 ± 0.01 | 2.00 ± 0.07 | 1.14 ± 0.04 | — |
| Control | 3.63 ± 0.01 | 2.78 ± 0.04 | 1.27 ± 0.06 | 16.18 ± 0.05 |

The results tabulated above indicate that the addition of the sorbents to the grape juice did not alter the pH and the sugar concentration. TPI was reduced by ~10% for BT and MMT, while in the presence of PVTC-MMT, TPI was only slightly reduced (~4%). Also, the color reduction by the CPN was minor.

### Example 10

### Removal of the OTA-Loaded Composite from GJ

To complete the OTA treatment process, one needs to remove the OTA-sorbent complexes from GJ. Sedimentation is a common technique in the winemaking industry to determine the effectiveness of the complex removal. The developed CPNs (PVTC-MMT and PVTC-MMT-FG of Examples 3 and 4, respectively) were compared with MMT and bentonite (BT) by monitoring sedimentation rate, GJ turbidity and GJ loss to sediment.

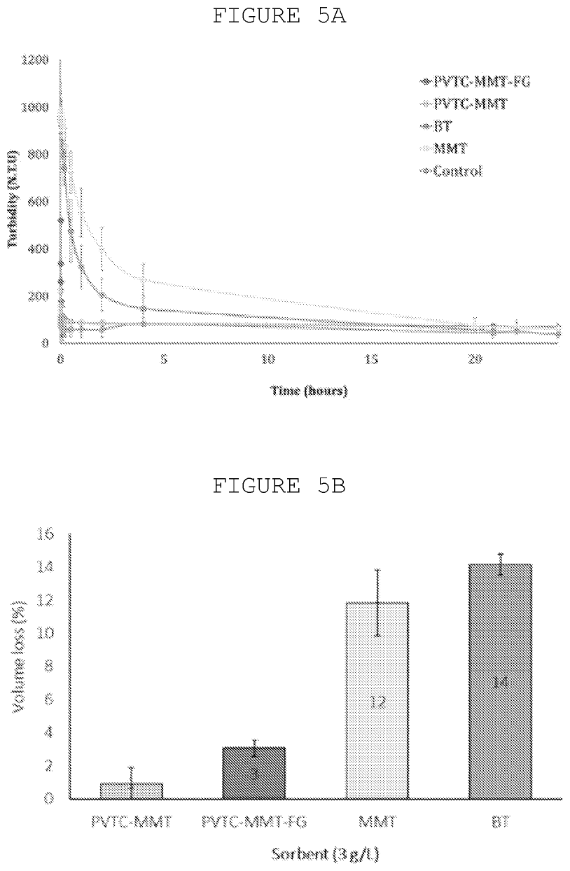

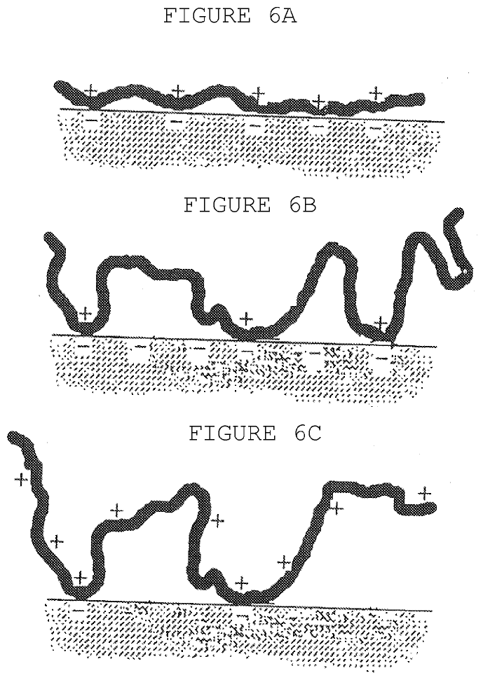

The results are shown in FIG. 5A, as turbidity versus time plots. The sedimentation rate of particles was determined from FIG. 5A as suspension turbidity is affected merely by the high concentration of sorbent particles (3 g/L) with relatively low turbidity of the GJ (~40 NTU). The sedimentation of the CPNs (PVTC-MMT and PVTC-MMT-FG) was significantly faster than that of the clays.

Particle size correlates to sedimentation rate, as described by Stock's law. Particle size distribution was measured in water (FIG. 2C) and sedimentation rates were calculated by relating particle radius to the median size of the particles. The median particle size of the CPNs was 125 and 300 μm (smaller for the ground CPN), two order of magnitudes larger than the median particle size of MMT and BT, 4 μm. Accordingly, the calculated sedimentation rates of the CPNs should be 2-4 orders of magnitude faster than those of the clays. The results calculated based on the Stock's law are tabulated in Table 6 alongside measured results.

TABLE 6

| | | | Sedimentation |
|---|---|---|---|
| | | | time |
| | | | in 4 cm |
| | | Sedimentation | high |
| | Median | velocity, | cylinder, |
| | particle | cm/sec | sec |
| Sorbent | size, μm | (calculated) | (measured) |
| PVTC-MMT | 301 | 4.5264 | 1 |
| PVTC-MMT-FG | 124 | 0.7682 | 5 |
| MMT | 4 | 0.0008 | 5106 |
| BT | 5 | 0.0011 | 3519 |
| GJ particles | 102 | 0.5198 | 8 |

The experimental results for sedimentation rate showed that CPNs were approximately 2 orders of magnitude faster than the clays (based on a 90% reduction in turbidity). The experimental results are in reasonable agreement with the calculated ones, despite the fact that the calculated rates are based on the median size of the particles in water with a broad distribution, and do not take into account the complex interactions of the sorbents with the GJ particles, which would increase sorbent size.

Once sedimentation was completed, the volume of the supernatant (clear GJ) was measured and the loss of GJ volume to the sediment was calculated. GJ volume loss to sediment was 10-fold lower for CPNs compared to clays (when applied at a concentration of 3 g/L), with losses of 1-3% and 12-14% for CPNs and clays, respectively, as shown in FIG. 5B.

### Example 11

### CPNs Based on Poly(Diallyl Dimethyl Ammonium Chloride) (PDADMAC) Composites

Composite adsorbents were prepared with varying ratios of polymer (PDADMAC) to clay (BT) and varying ionic strengths. BT was hydrated in tap water or in aqueous solution of sodium chloride to increase ionic strength, following which a solution of PDADMAC in tap water was added to the suspension of BT. The mixture was stirred overnight and the composite was separated by centrifugation. The obtained composite was rinsed twice with tap water (re-dispersing of the composite with tap water followed by centrifuge separation). The resulting composite was lyophilized (freeze-dried), milled and sieved to particle size up to 0.14 mm.

The effectiveness of the adsorbent in removing protein from white wine was determined by the heat stability test as published by the AWRI (Australian Wine Research Institute). The sediment volume, protein removal ability and total turbidity of the PDADMAC-BT-IS composites are presented in Table 7.

TABLE 7

| | PDADMAC/ | | | Protein | | |
|---|---|---|---|---|---|---|
| | BT ratio, | | Wine | removal | Protein | |
| | w/w | NaCl | entrapped | at 0.1 g/L | removal | Total |
| | (ratio in | content | in sediment | (ΔNTU) | at 1 g/L | turbidity |
| Example | preparation) | M | volume % | ±2 | (ΔNTU) | (NTU) ±2 |
| BT | — | — | 7.1 | 30 | 0 | 14 |
| Reference | | | | | | |
| 11A | 1/40 | 0.01 | 0.6 | 19 | 0 | 17 |
| 11B | 1/40 | 1 | 1.6 | 21 | 0 | 21 |
| 11C | 1/160 | 1 | 6.9 | 15 | 0 | 19 |
| 11D | 1/5 | Tap | 1.4 | — | 2.5 | 31 |
| | | water | | | | |
| 11E | 1/160 | Tap | 1.3 | — | 0 | 21 |
| | | water | | | | |
| 11F | 1/5 | 0.01 | 1.6 | — | 0.4 | 26 |
| 11G | 1/160 | 0.01 | 1.4 | — | 0 | 21 |
| 11H | 1/5 | 1 | 1.3 | — | 2.3 | 29 |

The reduction in volume (reduction in wine loss) for PDADMAC-clay composites was observed for all preparation combinations. For specific combinations, the total turbidity was as good as for commercial bentonite at 1 g/L. Protein removal (the most important parameter) was as good as commercial bentonite at 1 g/L and better than bentonite at 0.1 g/L sorbent.

Examples 11A-11B emerged as the best composite adsorbents, with 0.02 and 0.025 g PDADMAC per gram clay, respectively.

### Example 12

### CPNs Based on K-Carrageenan Composites

Composite adsorbents were prepared with varying ratios of polymer (κ-Carrageenan) to clay (BT). BT was hydrated in tap water. A solution of K-Carrageenan in distilled water was added to the suspension of MMT. The mixture was stirred overnight and the composite was separated by centrifugation. The obtained composite was rinsed twice with tap water (re-dispersing of the composite with tap water followed by centrifuge separation). The resulting composite was lyophilized (freeze-dried) and milled and sieved to particle size up to 0.14 mm.

The effectiveness of the adsorbent in removing protein from white wine was determined by the heat stability test as published by the AWRI (Australian Wine Research Institute). The sediment volume, protein removal ability and total turbidity of the PDADMAC-BT composites are presented in Table 8.

TABLE 8

| | | | Wine | Protein | |
|---|---|---|---|---|---|
| | | | entrapped | removal | |
| | K- | | in | at | |
| | Carrageenan/ | NaCl | sediment | 0.1 g/L | Total |
| Example | BT ratio, | content, | volume | (ΔNTU) | turbidity |
| | w/w | M | % | ±0.3 | (NTU) |
| BT | | | 7.1 | 4.8 | 0 |
| ( comparative) | | | | | |
| 12A | 1/5 | Tap water | 1.4 | 5.4 | 0.09 |
| 12B | 1/40 | Tap water | 1.1 | 4.0 | 0.09 |
| 12C | 1/160 | Tap water | 1.8 | 3.8 | 0.08 |

The reduction in volume for Carrageenan-clay was observed. For specific preparation combinations, the protein removal (the most important parameter) was as good as for commercial bentonite at 0.1 g/L sorbent.

1. A method for reducing the amount of one or more undesired agents in a beverage, comprising:
a) contacting the beverage with a composite adsorbent which comprises a montmorillonite (MMT) clay with a consumable polyelectrolyte adsorbed onto the clay, wherein charged binding sites of the clay are partially masked;
b) maintaining or applying conditions enabling binding of the undesired agent(s) to the composite adsorbent of (a); and
c) separating the composite adsorbent, with undesired agent bound thereto, from the beverage.

2. The method according to claim 1, wherein the beverage is selected from the group consisting of wines, juices, beers, and fermented drinks.

3. The method according to claim 1, wherein the undesired agent is selected from the group consisting of:
particles of skins, seeds, and stems of the fruit from which the beverage is made;
particles of grains from which the beer is made;
haze-forming proteins; and
bacteria, fungi, and toxic substances originating from microorganisms.

4. The method according to claim 3, wherein the toxic substances comprise mycotoxins selected from aflatoxins, zearalenone, fumonisins, trichothecenes and ochratoxins.

5. The method according to claim 1, wherein a cationic polyelectrolyte is adsorbed onto the clay.

6. The method according to claim 5, wherein the repeat unit of the cationic polyelectrolyte comprises a quaternary nitrogen, wherein the nitrogen is a ring atom or part of acyclic group.

7. (canceled)

8. The method according to claim 6, wherein the cationic polyelectrolyte is selected from the group consisting of:

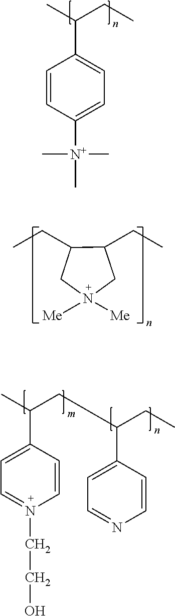

9. (canceled)

10. The method according to claim 8, comprising reducing the amount of ochratoxin A in beverages wherein the cationic polyelectrolyte consists of the poly(vinylbenzyl trimethyl ammonium) cation.

11. (canceled)

12. The method according to claim 8, comprising reducing the amount of haze-forming proteins in beverages, wherein the cationic polyelectrolyte consists of the poly(diallyl dimethyl ammonium) cation.

13. The method according to claim 1, wherein an anionic polyelectrolyte is adsorbed onto the clay.

14. The method according to 13, wherein the repeat unit of the anionic polyelectrolyte comprises a carboxylic and/or sulfonic acids groups.

15. (canceled)

16. (canceled)

17. The method according to claim 14, comprising reducing the amount of haze-forming proteins in beverages, wherein the anionic polyelectrolyte is kappa-carrageenan.

18. The method according to claim 1, wherein the charged binding sites of the clay are partially masked to the extent that the cation exchange capacity of the clay to Pb²⁺ is in the range from 0.1 to 0.3 mmol/g.

19. The method according to am claim 1, wherein the conditions maintained or applied in step (b) comprise stirring the composite adsorbent in the beverage, wherein the dose of the composite adsorbent from 0.1 to 2 g/liter of the liquid to be treated, and the duration of contact is between 1 hour and seven days.

20. The method according to claim 1, wherein the separation of the composite adsorbent from the beverage in step (c) comprises sedimentation, followed by filtration, decantation, or centrifugation.

21. The method according to claim 1, wherein the composite adsorbent consists of particles with particle size distribution having median of less than 300 μm, as determined by laser granulometry particle size analyzer; or mesh size of <140 μm.

22. (canceled)

23. A process for preparing a composite adsorbent, comprising combining an aqueous solution of a polyelectrolyte and a suspension of montmorillonite-based clay in water, stirring the resultant mixture, separating the solid particles, washing and drying, reducing the particle size to obtain ground particles and optionally sieving to ground particles to collect a population of particles with reduced particle size.

24. A process according to claim 23, wherein the polyelectrolyte is poly(diallyl dimethyl ammonium chloride), and stirring is performed at high ionic strength created by the presence of a salt.

25. A process according to claim 24, wherein the ratio between the polymer and montmorillonite-based clay is in the range of 1/20-1/80.

26. (canceled)

27. (canceled)

28. Freeze-dried, ground composite adsorbent having particle size in the range <300 μm, comprising:
montmorillonite and poly(diallyl dimethyl ammonium) with 0.015 to 0.15 g polymer per gram of clay;
montmorillonite and carrageenan, with 0.01 to 0.07 g polymer per gram of clay; or
montmorillonite and poly(vinyl benzyl trimethyl ammonium) with 0.015 to 0.15 g polymer per gram of clay.
